(19) United States
(12) Patent Application Publication
(10) Pub. No.: US 2025/0153156 A1
(43) Pub. Date: May 15, 2025

(54) CATALYST, METHOD OF PREPARATION, AND METHODS INVOLVING HYDROSILYLATION

(71) Applicants: DOW SILICONES CORPORATION, Midland, MI (US); THE BOARD OF TRUSTEES OF THE UNIVERSITY OF ILLINOIS, Urbana, IL (US)

(72) Inventors: Matthew JELETIC, Midland, MI (US); Alison WEITZEL, Urbana, IL (US); Ericka BRUSKE, Urbana, IL (US); Michael Salvatore FERRITO, Midland, MI (US); Zachary WENZLICK, Midland, MI (US); Kenneth ZIMMERMAN, Midland, MI (US)

(21) Appl. No.: 18/725,701

(22) PCT Filed: Dec. 28, 2022
(86) PCT No.: PCT/US2022/054167

§ 371 Date: Jun. 28, 2024

Related U.S. Application Data
(60) Provisional application No. 63/295,145, filed on Dec. 30, 2021.

(51) Int. Cl. B01J 31/22; C08G 77/08

(52) U.S. Cl. CPC B01J 31/2273; C08G 77/08; B01J 2231/323; B01J 2531/828

(57) ABSTRACT

A catalyst for hydrosilylation comprises a complex having a certain formula. The catalyst includes an imidazole moiety including at least one pendent substituent having a terminal ethylenic unsaturated group. A method of preparing the catalyst comprises reacting a platinum complex and an imidazole compound in the presence of a base reagent. A composition comprising the catalyst, an unsaturated compound (A), and optionally a silicon hydride compound (B) is further disclosed, along with a method of preparing a hydrosilylation reaction product.

### CROSS REFERENCE TO RELATED APPLICATIONS

The application claims priority to and all advantages of U.S. Provisional Patent Application No. 63/295,145 filed on 30 Dec. 2021, the content of which is incorporated herein by reference.

### FIELD OF THE INVENTION

The present invention generally relates to a catalyst and, more specifically, to a catalyst for hydrosilylation and to a method for preparing the catalyst. The present invention also relates to compositions including the same and related methods.

### BACKGROUND

Hydrosilylation reactions are generally known in the art and involve an addition reaction between silicon-bonded hydrogen and aliphatic unsaturation. Hydrosilylation reactions are utilized in various applications. For example, curable compositions often rely on hydrosilylation reactions for purposes of curing or crosslinking components thereof to give a cured product. Hydrosilylation reactions may also be utilized to prepare individual components or compounds, e.g. components for inclusion in curable compositions.

Hydrosilylation reactions are carried out in the presence of a catalyst, which is typically a platinum metal due to its excellent catalytic activity. Metal complexes can also be utilized to catalyze hydrosilylation reactions.

In certain types of hydrosilylation-reaction products, including certain silicone elastomers, metal complexes can migrate within the hydrosilylation-reaction products, which results in an increase in viscosity and/or modulus associated with further cure and higher crosslink density. An increase in viscosity and/or modulus undesirably reduces shelf-life stability of such hydrosilylation-reaction products and is commonly referred to in the art as viscosity drift. Conventional hydrosilylation-reaction products include hydrosilylation inhibitors and/or SiH scavengers to prevent such viscosity drift. However, use of hydrosilylation inhibitors can also be undesirable for myriad reasons.

### BRIEF SUMMMARY

The present invention provides a catalyst for hydrosilylation. The catalyst comprises a complex having the following structure:

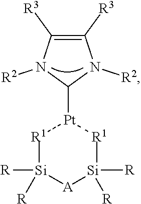

wherein A is O or N; each R is an independently selected hydrocarbyl group; each R¹ is an independently selected ethylenically unsaturated group; each R² is an independently selected hydrocarbyl group, with the proviso that at least one of R² includes terminal ethylenic unsaturation; and each R³ is independently selected from H and R, with the proviso that when each R³ is R, two of R³ may be bonded together as a ring structure.

The present invention further provides a method of preparing the catalyst. The method comprises reacting a platinum complex and an imidazole compound in the presence of a base reagent to give the catalyst for hydrosilylation. The platinum complex is of the formula:

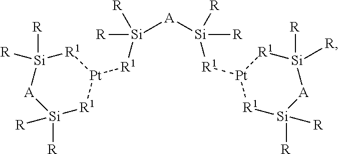

where R, R¹, and A are independently selected and defined above. The imidazole compound is of the formula:

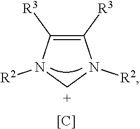

where each R² and each R³ is independently selected and defined above, and C⁻ is a counterion.

Further, the present invention provides a composition. The composition comprises (A) an unsaturated compound including at least one aliphatically unsaturated group per molecule, subject to at least one of the following two provisos: (1) the unsaturated compound (A) also includes at least one silicon-bonded hydrogen atom per molecule; and/or (2) the composition further comprises (B) a silicon hydride compound including at least one silicon-bonded hydrogen atom per molecule. The composition further comprises the catalyst.

A method of preparing a hydrosilylation reaction product is also provided. The method comprises reacting an aliphatically unsaturated group and a silicon-bonded hydrogen atom in the presence of the catalyst to give the hydrosilylation reaction product. The aliphatically unsaturated group is present in the unsaturated compound (A), which is subject to the same provisos noted above in regards to the composition.

A method of extending stability of a silicone elastomer blend is also provided. The method comprising combining a hydrosilylation-curable silicone composition and the catalyst to give a silicone elastomer blend having extended stability.

### DETAILED DESCRIPTION OF THE INVENTION

The present invention provides a catalyst. The catalyst has excellent physical properties and catalytic activity in hydrosilylation reactions. The catalyst is particularly suitable for providing extended shelf life and stability of silicone elastomers and pastes by preventing viscosity drift, as described below.

The catalyst comprises a complex having the following structure:

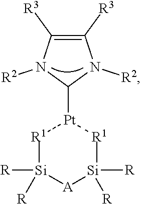

wherein A is O or N; each R is an independently selected hydrocarbyl group; each R¹ is an independently selected ethylenically unsaturated group; each R² is an independently selected hydrocarbyl group, with the proviso that at least one of R² includes terminal ethylenic unsaturation; and each R³ is independently selected from H and R, with the proviso that when each R³ is R, two of R³ may be bonded together as a ring structure.

Each R is independently selected and may be linear, branched, cyclic, or combinations thereof. Cyclic hydrocarbyl groups encompass aryl groups as well as saturated or non-conjugated cyclic groups. Cyclic hydrocarbyl groups may be monocyclic or polycyclic. Linear and branched hydrocarbyl groups may independently be saturated or unsaturated. One example of a combination of a linear and cyclic hydrocarbyl group is an aralkyl group. By “substituted,” it is meant that one or more hydrogen atoms may be replaced with atoms other than hydrogen (e.g. a halogen atom, such as chlorine, fluorine, bromine, etc.), or a carbon atom within the chain of R may be replaced with an atom other than carbon, i.e., R may include one or more heteroatoms within the chain, such as oxygen, sulfur, nitrogen, etc. Typically, each R is free from heteroatoms. Suitable alkyl groups are exemplified by, but not limited to, methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, as well as branched saturated hydrocarbon groups of 6 carbon atoms. Suitable aryl groups are exemplified by, but not limited to, phenyl, tolyl, xylyl, naphthyl, benzyl, and dimethyl phenyl. Suitable alkenyl groups include vinyl, allyl, propenyl, isopropenyl, butenyl, isobutenyl, pentenyl, heptenyl, hexenyl, and cyclohexenyl groups. Suitable monovalent halogenated hydrocarbon groups include, but are not limited to, a halogenated alkyl group of 1 to 6 carbon atoms, or a halogenated aryl group of 6 to 10 carbon atoms. Suitable halogenated alkyl groups are exemplified by, but not limited to, the alkyl groups described above where one or more hydrogen atoms is replaced with a halogen atom, such as F or Cl. For example, fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl are examples of suitable halogenated alkyl groups. Suitable halogenated aryl groups are exemplified by, but not limited to, the aryl groups described above where one or more hydrogen atoms is replaced with a halogen atom, such as F or Cl. For example, chlorobenzyl and fluorobenzyl are suitable halogenated aryl groups.

In specific embodiments, each R is an independently selected alkyl group, which may be linear, branched, cyclic (e.g. cycloalkyl), or combinations thereof. In certain embodiments, each R is a linear or branched alkyl group. In specific embodiments, each R is a linear alkyl group.

Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, and octadecyl, as well as branched saturated hydrocarbon groups having from 6 to 8 carbon atoms. Examples of suitable non-conjugated cyclic groups (i.e., cycloalkyl groups) include cyclobutyl, cyclohexyl, and cycyloheptyl groups.

In certain embodiments, each R is an alkyl group and independently has from 1 to 8, alternatively from 1 to 7, alternatively from 1 to 6, alternatively from 1 to 5, alternatively from 1 to 4, alternatively from 1 to 3, alternatively from 1 to 2, alternatively 1, carbon atoms.

Each R¹ is an independently selected ethylenically unsaturated group. Examples of ethylenically unsaturated groups generally include substituted or unsubstituted hydrocarbon groups having at least one alkene or alkyne functional group. For example, in certain embodiments, each R¹ comprises, alternatively is, an alkenyl group or an alkynyl group. In certain embodiments, each R¹ has from 1 to 20, alternatively from 1 to 15, alternatively from 1 to 10, alternatively from 1 to 8, carbon atoms. Specific examples thereof include H₂C═CH—, H₂C═CHCH₂—, H₂C═CHCH₂CH₂—, H₂C═CH(CH₂)₃—, H₂C═CH(CH₂)₄—, H₂C═C(CH₃)—, H₂C═C(CH₃)CH₂—, H₂C═C(CH₃)CH₂CH₂—, H₂C═C(CH₃)CH₂CH(CH₃)—, H₂C═C(CH₃)CH(CH₃)CH₂—, H₂C═C(CH₃)C(CH₃)₂—, HC≡C—, HC≡CCH₂—, HC═CCH(CH₃)—, HC≡CC(CH₃)₂—, and HC≡CC(CH₃)₂CH₂—. In specific embodiments, each R¹ comprises, alternatively is, a vinyl group.

Each R² is an independently selected hydrocarbyl group, with the proviso that at least one of R² includes terminal ethylenic unsaturation. Suitable examples of hydrocarbyl groups are described above for R. Similarly, suitable groups having terminal ethylenic unsaturation are described above for R¹. The difference between R¹ and R² is that the ethylenic unsaturation need not be terminal in R¹, though the ethylenic unsaturation is typically terminal in both R¹ and R². In one embodiment, only one of R² includes terminal ethylenic unsaturation. In another embodiment, both of R² include terminal ethylenic unsaturation.

In specific embodiments, at least one of R² has the formula —(CH₂)ₙCH═CH₂, where n is independently from 2 to 8, alternatively from 2 to 7, alternatively from 2 to 6.

In certain embodiments, each R, each R¹ and each R² is independently selected based on a factor such as steric hindrance, electronics (e.g. electron donative, inductive, or withdrawing effects), and the like, or combinations thereof. R, R¹ and R² may be selected to impart symmetry to the catalyst. In these or other embodiments, R, R¹ and R² may be independently selected to enforce reactive regioselectivity.

In one specific embodiment, each R is methyl; each R¹ is vinyl; each R² includes terminal ethylenic unsaturation; each R³ is H; and A is O. In these embodiments, the catalyst has the following structure:

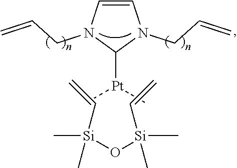

where each subscript n is independently from 2 to 8.

The catalyst may optionally be disposed in a vehicle, e.g. a solvent which solubilizes the catalyst, alternatively a vehicle which merely carries or disperses, but does not solubilize, the catalyst. Such vehicles are known in the art.

Suitable vehicles include silicones, both linear and cyclic, organic oils, organic solvents and mixtures of these. For example, relative to silicones, the carrier vehicle may comprise a polydialkylsiloxane, e.g. polydimethylsiloxane.

The vehicle may also be a low viscosity organopolysiloxane or a volatile methyl siloxane or a volatile ethyl siloxane or a volatile methyl ethyl siloxane having a viscosity at 25° C. in the range of 1 to 1,000 mm²/sec, such as hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, and any mixtures thereof.

Alternatively, the vehicle may comprise an organic solvent. Examples of organic solvents include: aromatic hydrocarbons, such as benzene, toluene, xylene, mesitylene, etc.; aliphatic hydrocarbons, such as heptane, hexane, octane, etc.; glycol ethers, such as propylene glycol methyl ether, dipropylene glycol methyl ether, propylene glycol n-butyl ether, propylene glycol n-propyl ether, ethylene glycol n-butyl ether, etc.; halogenated hydrocarbons, such as dichloromethane, 1,1,1-trichloroethane, and chloroform; ketones, such as acetone, methylethyl ketone, or methyl isobutyl ketone; acetates, such as ethyl acetate, butyl acetate, ethylene glycol monoethyl ether acetate, and propylene glycol methyl ether acetate; alcohols, such as methanol, ethanol, isopropanol, butanol, or n-propanol; and others organic compounds that present as liquid/fluid at typical reaction temperatures, such as dimethyl sulfoxide, dimethyl formamide, acetonitrile, tetrahydrofuran, white spirits, mineral spirits, naphtha, n-methylpyrrolidone; and the like, as well as derivatives, modifications, and combination thereof.

The catalyst may also be in crystalized form, e.g. grown from a supersaturated solution in the vehicle. However, the catalyst is typically homogenous and not heterogeneous so as to maximize contact interaction with components of and catalysis in hydrosilylation reactions. Further, advantages of the catalyst are maximized when the catalyst is homogenous.

In particular, when preparing conventional silicone elastomers, and in particular silicone gels and/or pastes, conventional hydrosilylation catalysts based on platinum, including Karstedt's catalyst, are prone to migration or movement within such elastomers over time, i.e., conventional catalysts are mobile within certain forms of conventional silicone elastomers. Movement or migration of such conventional hydrosilylation catalysts results in an increase in viscosity and/or modulus over time due to further crosslinking attributable to the conventional hydrosilylation catalysts. To prevent such increases in viscosity and/or modulus, which are undesirable as limiting shelf-life stability, inhibitors and/or SiH scavengers are typically utilized, which reduce catalytic activity of conventional hydrosilylation catalysts. However, inhibitors and SiH scavengers add cost and complexity, and can introduce color, which is often undesirable. In contrast, however, the inventive catalyst is generally immobilized in silicone elastomers, thus minimizing or preventing such an increase in viscosity and/or modulus over time. Therefore, the inventive catalyst allows for avoidance of conventional inhibitors and SiH scavengers while still minimizing or preventing an increase in viscosity and/or modulus over time, which is particularly advantageous.

The present invention further provides a method of preparing the catalyst. The method comprises reacting a platinum complex and an imidazole compound in the presence of a base reagent to give the catalyst for hydrosilylation.

The platinum complex is of the formula:

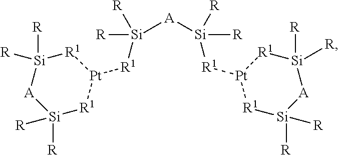

where R, R¹, and A are independently selected and defined above.

As with the description above for the catalyst, in some embodiments, each A is O, each R is an independently selected alkyl group, and each R¹ is an independently selected alkenyl group. In specific embodiments, each A is O, each R is methyl and each R¹ is methyl. In these embodiments, the platinum complex has the following structure:

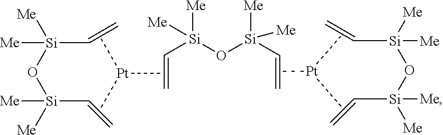

where Me designates methyl. As known in the art, this particular platinum complex is known as Karstedt's catalyst.

The platinum complex, and thus the resulting catalyst formed therewith, may be single site or multi-site complex. Typically, the platinum complex is a homogeneous multi-site platinum complex, e.g. a dimer. However, the platinum complex may also comprise single site or monomeric species.

The imidazole compound is of the formula:

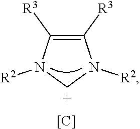

where each R² and each R³ is independently selected and defined above, and C⁻ is a counterion. Generally, the counterion C⁻ is selected so that the imidazole compound is charge balanced.

C⁻ is not limited, and may be any anion. Suitable anions include halides, sulfonates (e.g., tosylate), borates, phosphates, antimonates, and the like. In certain embodiments, C⁻ is selected from a halide, trifluoromethylsulfonate (OTf⁻), tetrafluoroborate (BF₄⁻), hexafluorophosphate (PF₆⁻), tetrakis[3,5-bis(trifluoromethyl)phenyl]borate ([{3,5-(CF₃)₂C₆H₃}₄B]⁻), tetrakis(pentafluorophenyl)borate ((F₅C₆)₄B⁻) and hexafluoroantimonate (SbF₆⁻).

Specific examples of suitable imidazole compounds when each R³ is H, each R² is pentenyl or butenyl, and C⁻ is BF₄ include the following:

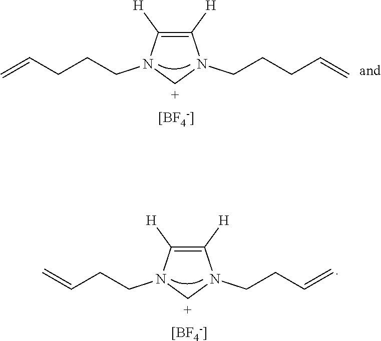

The catalyst is prepared by first deprotonating the imidazole compound in the presence of a base reagent. The base reagent is typically a strong base reagent. Examples of strong base reagents suitable for the base reagent include organic base reagents, organometallic base reagents, inorganic base reagents, and combinations thereof.

Specific examples of organic base reagents include nitrogen-containing compounds. In some embodiments, the nitrogen-containing compounds also have low nucleophilicity and relatively mild conditions of use. Non-limiting examples of nitrogen-containing compounds include phosphazenes, amidines, guanidines, and multicyclic polyamines. Organic base reagents also include compounds where a reactive metal has been exchanged for a hydrogen on a heteroatom, such as oxygen (unstabilized alkoxides) or nitrogen (metal amides such as lithium diisopropylamide). In some embodiments, the base reagent comprises or is an amidine compound.

Specific examples of organometallic base reagent include organolithium and organomagnesium (Grignard reagent) compounds. Another example of an organometallic base reagent is potassium bis(trimethyl) silyl amide. In some embodiments, the organometallic base reagents are hindered to the extent necessary to make them non-nucleophilic.

Specific examples of inorganic base reagents include salt compounds. Non-limiting examples of inorganic base reagents include lithium nitride and alkali-and alkali earth metal hydrides, including potassium hydride and sodium hydride. Such species are insoluble in all solvents owing to the strong cation-anion interactions, but the surfaces of these materials are highly reactive and slurries can be used. Another example of an inorganic base reagent is cesium carbonate.

In specific examples, the base reagent is selected from lithium hydride, sodium hydride, potassium hydride, sodium methoxide, sodium tert-butoxide, sodium ethoxide, potassium tert-butoxide, potassium ethoxide, sodium tert-pentoxide, and combinations thereof.

Typically, the catalyst is formed from a molar or stoichiometric ratio of the imidazole compound to the platinum complex of from 1:2 to 2:1, alternatively from 1:1.9 to 1.9:1, alternatively from 1:1.8 to 1.8:1, alternatively from 1:17 to 1.7:1, alternatively from 1.6:1 to 1.6:1; alternatively from 1:1.5 to 1.5:1; alternatively from 1:1.4 to 1.4:1; alternatively from 1:1.3 to 1.3:1; alternatively from 1:1.2 to 1.2:1; alternatively from 1:1.1 to 1.1:1; alternatively from 1:1.05 to 1.05:1; alternatively 1:1.

The reaction to prepare the catalyst may be carried out in a carrier, examples of which are described above. Typically, the carrier is an organic solvent. The reaction can be carried out at ambient conditions, but is typically carried out in an inert atmosphere (e.g. nitrogen), optionally while selectively controlling or modifying ambient conditions, including temperature, pressure, exposure to ultraviolet light, etc. The catalyst is typically prepared in a reaction product, but can be isolated therefrom via techniques known in the art (e.g. filtration and solvent washing).

As introduced above, the present invention also provides a composition. The composition comprises (A) an unsaturated compound. The unsaturated compound (A) includes at least one aliphatically unsaturated group per molecule, which may alternatively be referred to as ethylenic unsaturation. The unsaturated compound (A) is not limited and may be any unsaturated compound having at least one aliphatically unsaturated group. In certain embodiments, the unsaturated compound (A) comprises an organic compound. In other embodiments, the unsaturated compound (A) comprises a siloxane. In yet other embodiments, the unsaturated compound (A) comprises a silicone-organic hybrid, or an organosilicon compound. Various embodiments and examples of the unsaturated compound (A) are disclosed below.

In certain embodiments, the unsaturated compound (A) includes an average of at least two aliphatically unsaturated groups per molecule. In such embodiments, the unsaturated compound (A) is capable of polymerization or curing beyond single cure-site hydrosilylation. The aliphatically unsaturated groups of the unsaturated compound (A) may be terminal, pendent, or in both locations in the unsaturated compound (A).

For example, the aliphatically unsaturated group may be an alkenyl group and/or an alkynyl group. “Alkenyl group”means an acyclic, branched or unbranched, monovalent hydrocarbon group having one or more carbon-carbon double bonds. The alkenyl group may have from 2 to 30 carbon atoms, alternatively from 2 to 24 carbon atoms, alternatively from 2 to 20 carbon atoms, alternatively from 2 to 12 carbon atoms, alternatively from 2 to 10 carbon atoms, alternatively from 2 to 6 carbon atoms. Alkenyl groups are exemplified by, but not limited to, vinyl, allyl, propenyl, and hexenyl. “Alkynyl group”means an acyclic, branched or unbranched, monovalent hydrocarbon group having one or more carbon-carbon triple bonds. The alkynyl group may have from 2 to 30 carbon atoms, alternatively from 2 to 24 carbon atoms, alternatively from 2 to 20 carbon atoms, alternatively from 2 to 12 carbon atoms, alternatively from 2 to 10 carbon atoms, alternatively from 2 to 6 carbon atoms. Alkynyl is exemplified by, but not limited to, ethynyl, propynyl, and butynyl.

In specific embodiments, the unsaturated compound (A) has the formula R⁴—Z—R⁴, where Z is a divalent linking group, which may be a divalent hydrocarbon, a polyoxyalkylene, a polyalkylene, a polyisoalkylene, a hydrocarbon-silicone copolymer, a siloxane, or mixtures (in block or randomized form) thereof. Z may be linear or branched. In these specific embodiments, R⁴ is independently selected and includes aliphatic unsaturation, i.e., each R⁴ is independently selected from alkenyl groups and alkynyl groups. However, the aliphatic unsaturation need not be terminal in the unsaturated compound (A).

In these specific embodiments, the unsaturated compound (A) includes two aliphatically unsaturated groups represented by R².

In one embodiment of the unsaturated compound (A), Z is a divalent hydrocarbon. The divalent hydrocarbon Z may contain 1 to 30 carbons, either as aliphatic or aromatic structures, and may be branched or unbranched. Alternatively, the linking group Z may be an alkylene group containing 1 to 12 carbons. In these embodiments, the unsaturated compound (A) may be selected from α, ωunsaturated hydrocarbons. The α, ωunsaturated hydrocarbons may alternatively be referred to as olefins.

For example, the unsaturated compound (A) may be any diene, diyne or ene-yne compound. With reference to the formula above, in these embodiments, R⁴ may be, for example, independently selected from CH₂═CH—, CH₂═CHCH₂—, CH₂═CH(CH₂)₄—, CH₂═C(CH₃)CH₂— or and similar substituted unsaturated groups such as H₂C═C(CH₃)—, and HC═C(CH₃)—. In such embodiments, the unsaturated compound (A) may be referred to as an α,ω-unsaturated hydrocarbon. The α,ω-unsaturated hydrocarbon may be, for example, an α,ω-diene of the formula CH₂═CH(CH₂)_{b}CH═CH₂, an α,ω-diyne of the formula CH≡C(CH₂)_{b}C≡CH, an α,ω-ene-yne of the formula CH₂═CH(CH₂)_{b}C≡CH, or mixtures thereof, where b is independently from 0 to 20, alternatively from 1 to 20.

Specific examples of suitable diene, diyne or ene-yne compounds include 1,4-pentadiene, 1,11-1,5-hexadiene; 1,6-heptadiene; 1,7-octadiene, 1,8-nonadiene, 1,9-decadiene, dodecadiene, 1,13-tetradecadiene, and 1,19-eicosadiene, 1,3-butadiyne, 1,5-hexadiyne (dipropargyl), and 1-hexene-5-yne.

However, the unsaturated compound (A) may alternatively have the formula R⁴—Z′, where R⁴ is defined above and Z′ is a monovalent hydrocarbon group (or silyl or siloxane group). In these specific embodiments, the unsaturated compound (A) includes one aliphatically unsaturated group represented by R⁴.

When the unsaturated compound (A) includes only one aliphatically unsaturated group, the unsaturated compound (A) may be referred to as an unsaturated hydrocarbon, and may be any -ene or -yne compound. In such embodiments, the unsaturated compound (A) may be an acyclic alkene and/or an acyclic alkyne. However, the unsaturated compound (A) may include aryl groups so long as the unsaturated compound (A) also includes the at least one aliphatically unsaturated group independent from any aryl groups, e.g. pendent therefrom.

In another embodiment, the unsaturated compound (A) comprises, alternatively is, a polyether. In these embodiments, the unsaturated compound (A) comprises a polyoxyalkylene group having the formula (CₐH₂ₐO), wherein a is from 2 to 4 inclusive. With reference to the general formula above, Z′ is the polyoxyalkylene group. In these embodiments, the unsaturated compound (A) may be referred to as the polyoxyalkylene.

The polyoxyalkylene may comprise oxyethylene units (C₂H₄O), oxypropylene units (C₃H₆O), oxybutylene or oxytetramethylene units (C₄H₈O), or mixtures thereof, which may be in block form or randomized in the unsaturated compound (A).

For example, the unsaturated compound (A) as the polyoxyalkylene may have the following general formula:

R⁴O—[(C₂H₄₀)_{c}(C₃H₆O)_{d}(C₄H₈O)ₑ]—R⁴

wherein each R⁴ is independently selected and defined above; c is from 0 to 200, d is from 0 to 200, and e is from 0 to 200, with the proviso that c, d and e are not simultaneously 0. In specific embodiments, c is from 0 to 50, alternatively from 0 to 10, alternatively from 0 to 2. In these or other embodiments, d is from 0 to 100, alternatively 1 to 100, alternatively 5 to 50. In these or other embodiments, e is from 0 to 100, alternatively 0 to 50, alternatively 0 to 30. In various embodiments, the ratio of (d+e)/(c+d+e) is greater than 0.5, alternatively greater than 0.8, or alternatively greater than 0.95.

This polyoxyalkylene is terminated at each molecular chain end (i.e. alpha and omega positions) with R⁴, which is independently selected and described above. Additional examples of R² include H₂C═C(CH₃)CH₂—H₂C═CHCH₂CH₂—, H₂C═CHCH₂CH₂CH₂—, and H₂C═CHCH₂CH₂CH₂CH₂—, HC≡C—, HC≡CCH₂—, HC≡CCH(CH₃)—, HC═CC(CH₃)₂—, HC≡CC(CH₃)₂CH₂—. However, the polyoxyalkylene set forth above is merely one exemplary example of a suitable polyoxyalkylene.

In specific embodiments, the polyoxyalkylene group comprises only oxypropylene units (C₃H₆O). Representative, non-limiting examples of polyoxypropylene-containing polyoxyalkylenes include: H₂C═CHCH₂[C₃H₆O]_{d}CH₂CH═CH₂, H₂C═CH [C₃H₆O]_{d}CH═CH₂, H₂C═C(CH₃)CH₂[C₃H₆O]_{d}CH₂C(CH₃)═CH₂, HC≡CCH₂[C₃H₆O]_{d}CH₂C═CH, and HC≡CC(CH₃)₂[C₃H₆O]_{d}C(CH₃)₂C≡CH, where d is as defined above.

Representative, non-limiting examples of polyoxybutylene or poly (oxytetramethylene) containing polyoxyalkylenes include: H₂C═CHCH₂[C₄H₈O]ₑCH₂CH═CH₂, H₂C═CH [C₄H₈O]ₑCH≡CH₂, H₂C═C(CH₃)CH₂[C₄H₈O]ₑCH₂C(CH₃)═CH₂, HC≡CCH₂[C₄H₈O]ₑCH2C≡CH, and HC≡CC(CH₃)₂[C₄H₈O]ₑC(CH₃)₂C≡CH, where e is as defined above.

The examples of polyoxyalkylenes suitable for (A) the unsaturated compound include two aliphatically unsaturated groups. However, the polyoxyalkylene suitable for (A) the unsaturated compound may include only one aliphatically unsaturated group. For example, the polyoxyalkylene suitable for (A) the unsaturated compound may alternatively have the following general formula:

R⁴O—[(C₂H₄O)_{c}(C₃H₆O)_{d}(C₄H₈O)ₑ]—R⁵

where R⁴, c, d, and e are defined above, and R⁵ is H or an alkyl group, such as CH₃. Any description or examples above also apply to this embodiment as well. One of skill in the art readily understands how the examples of polyoxyalkylenes above with two aliphatically unsaturated groups may alternatively include but one aliphatically unsaturated group.

The polyoxyalkylene may be prepared by, for example, the polymerization of ethylene oxide, propylene oxide, butylene oxide, 1,2-epoxyhexane, 1,2-epoxyoctance, and/or cyclic epoxides, such as cyclohexene oxide or exo-2,3-epoxynorborane. The polyoxyalkylene moiety of the polyoxyalkylene may comprise oxyethylene units (C₂H₄O), oxypropylene units (C₃H₆O), oxybutylene units (C₄H₈O), or mixtures thereof. Typically, the polyoxyalkylene group comprises a majority of oxypropylene or oxybutylene units, as defined on a molar basis and indicated in the above formula by the c, d, and e subscripts.

In another embodiment, Z of the general formula R⁴—Z—R⁴ or Z′ or the formula R⁴—Z′ of the unsaturated compound (A) comprises a polyalkylene group. The polyalkylene group may comprise from C₂ to C₆ alkylene units or their isomers. One specific example is polyisobutylene group, which is a polymer including isobutylene units. For example, the unsaturated compound (A) may be a di-allyl terminated polyisobutylene or an allyl-terminated polyisobutylene. The molecular weight of the polyisobutylene group may vary, but typically ranges from 100 to 10,000 g/mole.

In certain embodiments, the unsaturated compound (A) comprises an organopolysiloxane. The organopolysiloxane is not limited and may be any organopolysiloxane including at least one silicon-bonded aliphatically unsaturated group per molecule. For example, the organopolysiloxane may be linear, branched, partly branched, cyclic, resinous (i.e., have a three-dimensional network), or may comprise a combination of different structures. When the unsaturated compound (A) comprises the organopolysiloxane, the aliphatically unsaturated group is silicon-bonded (e.g. as silicon-bonded alkenyl and/or silicon-bonded alkynyl).

In certain embodiments when the unsaturated compound (A) comprises an organopolysiloxane, the organopolysiloxane has the following average formula:

R⁶_{f}SiO_{(4-f)}/2

wherein each R⁶ is an independently selected substituted or unsubstituted hydrocarbyl group with the proviso that in each molecule, at least one, alternatively at least two, R⁶ groups is an aliphatically unsaturated group, and wherein f is selected such that 0<f≤3.2.

The average formula above for the organopolysiloxane may be alternatively written as (R⁶₃SiO_{1/2})_{w}(R⁶₂SiO_{2/2})ₓ(R⁶SiO_{3/2})_{y}(SiO_{4/2})_{z}, where R⁶ and its proviso is defined above, and w, x, y, and z are independently from ≥0 to ≤1, with the proviso that w+x+y+z=1. One of skill in the art understands how such M, D, T, and Q units and their molar fractions influence subscript f in the average formula above. T and Q units, indicated by subscripts y and z, are typically present in silicone resins, whereas D units, indicated by subscript x, are typically present in silicone polymers (and may also be present in silicone resins).

Each R⁶ is independently selected, as introduced above, and may be linear, branched, cyclic, or combinations thereof. In general, hydrocarbyl groups suitable for R⁶ may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, octadecyl, as well as branched saturated hydrocarbon groups having from 6 to 18 carbon atoms. Examples of suitable non-conjugated cyclic groups include cyclobutyl, cyclohexyl, and cycyloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, hexadecenyl, octadecenyl and cyclohexenyl groups. Examples of suitable monovalent halogenated hydrocarbon groups (i.e., halocarbon groups, or substituted hydrocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as F or Cl. Specific examples of halogenated aryl groups include chlorobenzyl and fluorobenzyl groups.

In certain embodiments, the organopolysiloxane is substantially linear, alternatively is linear. By substantially linear, it is meant that the organopolysiloxane can include at least some branching attributable to T or Q, typically T, siloxy units, so long as at least 90, alternatively at least 95, mol % of siloxy units are D siloxy units. In these embodiments, the substantially linear organopolysiloxane may have the average formula:

R⁶_{f′}SiO_{(4-f′)}/2

wherein each R⁶ and its proviso are defined above, and wherein f′ is selected such that 1.9≤f′≤2.2.

In these embodiments, at a temperature of 25° C., the substantially linear organopolysiloxane is typically a flowable liquid or is in the form of an uncured rubber. Generally, the substantially linear organopolysiloxane has a viscosity of from 10 to 30,000,000 mPa·s, alternatively from 10 to 10,000 mPa·s, alternatively from 100 to 1,000,000 mPa·s, alternatively from 100 to 100,000 mPa·s, at 25° C. Viscosity may be measured at 25° C. via a Brookfield LV DV-E viscometer, as understood in the art.

In specific embodiments in which the organopolysiloxane is substantially linear or linear, the organopolysiloxane may have the average formula:

(R⁶₃SiO_{1/2})_{m′}(R⁶₂SiO_{2/2})_{n′}(R⁶SiO_{3/2})ₒ,

wherein each R⁶ is independently selected and defined above (including the proviso that in each molecule, at least one R⁶ is an aliphatically unsaturated group), and m′≥2, n′≥1, and o≥0. In specific embodiments, subscript m′ is from 2 to 10, alternatively from 2 to 8, alternatively from 2 to 6. In these or other embodiments, subscript n′ is from 1 to 1,000, alternatively from 1 to 500, alternatively from 1 to 200. In these or other embodiments, subscript o is from 0 to 10, alternatively from 0 to 5, alternatively from 0 to 2. As understood in the art, when subscript o is 0, the organopolysiloxane is linear.

When the organopolysiloxane is substantially linear, alternatively is linear, the silicon-bonded aliphatically unsaturated group(s) may be pendent, terminal or in both pendent and terminal locations. As a specific example of the organopolysiloxane having pendant silicon-bonded aliphatically unsaturated groups, the organopolysiloxane may have the average formula:

(CH₃)₃SiO[(CH₃)₂SiO]_{n′}[(CH₃)ViSiO]_{m′}Si(CH₃)₃

where n′ and m′ are defined above, and Vi indicates a vinyl group. With regard to this average formula, one of skill in the art knows that any methyl group may be replaced with a vinyl or a substituted or unsubstituted hydrocarbyl group, and any vinyl group may be replaced with any ethylenically unsaturated group, so long as at least two aliphatically unsaturated groups are present per molecule. Alternatively, as a specific example of the organopolysiloxane having terminal silicon-bonded aliphatically unsaturated groups, the organopolysiloxane may have the average formula:

Vi(CH₃)₂SiO[(CH₃)₂SiO]_{n′}Si(CH₃)₂Vi

where n′ and Vi are defined above. The dimethyl polysiloxane terminated with silicon-bonded vinyl groups may be utilized alone or in combination with the dimethyl, methyl-vinyl polysiloxane disclosed immediately above. With regard to this average formula, one of skill in the art knows that any methyl group may be replaced with a vinyl or a substituted or unsubstituted hydrocarbyl group, and any vinyl group may be replaced with any ethylenically unsaturated group, so long as at least two aliphatically unsaturated groups are present per molecule. Because the at least two silicon-bonded aliphatically unsaturated groups may be both pendent and terminal, the (A) organopolysiloxane may have the average formula:

Vi(CH₃)₂SiO[(CH₃)₂SiO]_{n′}[(CH₃)ViSiO]_{m′}SiVi(CH₃)₂

where n′, m′ and Vi are defined above.

The substantially linear organopolysiloxane can be exemplified by a dimethylpolysiloxane capped at both molecular terminals with dimethylvinylsiloxy groups, a methylphenylpolysiloxane capped at both molecular terminals with dimethylvinylsiloxy groups, a copolymer of a methylphenylsiloxane and dimethylsiloxane capped at both molecular terminals with dimethylvinylsiloxy groups, a copolymer of a methylvinylsiloxane and a methylphenylsiloxane capped at both molecular terminals with dimethylvinylsiloxy groups, a copolymer of a methylvinylsiloxane and diphenylsiloxane capped at both molecular terminals with dimethylvinylsiloxy groups, a copolymer of a methylvinylsiloxane, methylphenylsiloxane, and dimethylsiloxane capped at both molecular terminals with dimethylvinylsiloxy groups, a copolymer of a methylvinylsiloxane and a methylphenylsiloxane capped at both molecular terminals with trimethylsiloxy groups, a copolymer of a methylvinylsiloxane and diphenylsiloxane capped at both molecular terminals with trimethylsiloxy groups, and a copolymer of a methylvinylsiloxane, methylphenylsiloxane, and a dimethylsiloxane capped at both molecular terminals with trimethylsiloxy groups.

In these or other embodiments, the (A) organopolysiloxane may be a resinous organopolysiloxane. In these embodiments, the resinous organopolysiloxane may have the average formula:

R⁶_{f″}SiO_{(4-f)}/2

wherein each R⁶ and its provisos are defined above, and wherein f″ is selected such that 0.5≤f″≤1.7.

The resinous organopolysiloxane has a branched or a three dimensional network molecular structure. At 25° C., the resinous organopolysiloxane may be in a liquid or in a solid form, optionally dispersed in a carrier, which may solubilize and/or disperse the resinous organopolysiloxane therein.

In specific embodiments, the resinous organopolysiloxane may be exemplified by an organopolysiloxane that comprises only T units, an organopolysiloxane that comprises T units in combination with other siloxy units (e.g. M, D, and/or Q siloxy units), or an organopolysiloxane comprising Q units in combination with other siloxy units (i.e., M, D, and/or T siloxy units). The resinous organopolysiloxane comprises T and/or Q units. A specific example of the resinous organopolysiloxane is a vinyl functional silsesquioxane, or a vinyl functional MQ resin.

The organopolysiloxane may comprise a combination or mixture of different organopolysiloxanes, including those of different structures.

Alternatively, the unsaturated compound (A) may be a silicone-organic hybrid. For example, the unsaturated compound (A) may comprise the hydrosilylation reaction product of organopolysiloxanes (or of one or more organopolysiloxanes with one or more organic compounds), in which case the backbone of the unsaturated compound (A) may include organic divalent linking groups. As another example, organohydrogensiloxanes may be reacted with other organopolysiloxanes, or with organic compounds, to give the unsaturated compound (A).

For example, the unsaturated compound (A) may be the reaction product of (a1) at least one Si—H compound and (b1) at least one compound having ethylenic unsaturation. In these embodiments, a molar excess of ethylenic unsaturated groups of the (b1) compound are utilized as compared to Si—H groups of the (a1) Si—H compound such that the unsaturated compound (A) includes at least one, alternatively an average of at least two, silicon-bonded aliphatically unsaturated groups.

The reaction product of the (a1) Si—H compound and the (b1) compound having ethylenic unsaturation may be referred to as an (AB) n type copolymer, with the (a1) Si—H compound forming units A and the (b1) compound having ethylenic unsaturation forming units B. Combinations of different (a1) Si—H compounds may be utilized, and combinations of different (b1) compounds having ethylenic unsaturation may be utilized, such that the resulting (b) crosslinking agent comprises distinct units but may not be an (AB)n type copolymer. The distinct units may be randomized or in block form.

Alternatively still, the unsaturated compound (A) may comprise an organosilicon-compound, but not an organopolysiloxane. For example, the unsaturated compound (A) may comprise a silane, a disilane, or a siloxane (for example a disiloxane), while not constituting an organopolysiloxane.

One example of a suitable silane is that of formula R⁶_{z″}SiR⁸_{4-z}″, where each R⁷ independently is an aliphatically unsaturated group, each R⁸ is independently a substituted or unsubstituted hydrocarbyl group, and 1≤z″≤4. One example of a siloxane is tetramethyldivinyldisiloxane. One of skill in the art understands how to prepare or obtain such compounds for use as the unsaturated compound (A).

The unsaturated compound (A) can be a single unsaturated compound or a combination comprising two or more different silicon hydride compounds.

The composition and unsaturated compound (A) are subject to at least one of the following two provisos: (1) the unsaturated compound (A) also includes at least one silicon- bonded hydrogen atom per molecule; and/or (2) the composition further comprises (B) a silicon hydride compound including at least one silicon-bonded hydrogen atom per molecule.

In a first embodiment, the proviso (1) is true such that the unsaturated compound (A) also includes at least one silicon-bonded hydrogen atom per molecule. In a second embodiment, the proviso (2) is true such that the composition further comprises (B) a silicon hydride compound including at least one silicon-bonded hydrogen atom per molecule. Finally, in a third embodiment, both proviso (1) and proviso (2) are true such that the unsaturated compound (A) also includes at least one silicon-bonded hydrogen atom per molecule, and that the composition further comprises (B) a silicon hydride compound including at least one silicon-bonded hydrogen atom per molecule.

In the first embodiment, the proviso (1) is true and the unsaturated compound (A) includes at least one silicon-bonded hydrogen atom per molecule in addition to the aliphatically unsaturated group. In these embodiments, the unsaturated compound (A) may be any compound including at least one silicon-bonded hydrogen atom and at least one aliphatically unsaturated group. In these embodiments, the unsaturated compound (A) is typically an organosilicon compound and/or an organopolysiloxane.

One of skill in the art readily understands how to prepare or obtain such unsaturated compounds. For example, organosilicon compounds including both aliphatic unsaturated and silicon-bonded hydrogen may be prepared from the unsaturated organic compounds disclosed above. As but one example, an α,ω-diene of the formula CH₂═CH(CH₂)_{b}CH═CH₂ may be reacted with a silane of formula H₂Si(CH₃)₂ in the presence of a hydrosilylation catalyst to give an unsaturated compound of formula CH₂═CH(CH₂)_{b}CH₂CH₂Si(CH₃)₂H, which includes one aliphatically unsaturated group and one silicon-bonded hydrogen atom. The organosilicon compound may also be a silane, disilane, siloxane, etc. For example, the organosilicon compound may be of formula R⁷_{b′}H_{c′}SiR⁸_{4-b′-c′}, where R⁷ and R⁸ are independently selected and defined above, b′ is 1, 2, or 3, c′ is 1, 2, or 3, with the proviso that 2≤(b′+c′)≤4.

When the unsaturated compound (A) comprises the organopolysiloxane having both aliphatic unsaturation and silicon-bonded hydrogen, the organopolysiloxane may have the formula R⁶_{d′}H_{e′}SiO_{(4-d′-e′)}/2, where R⁶ is independently selected and defined above (still subject to the proviso that at least one R⁶ is the aliphatically unsaturated group), and e′ and f′ are each greater than 0 such that 0<(d′+e′)≤3.2.

Alternatively, when the unsaturated compound (A) comprises the organopolysiloxane having both aliphatic unsaturation and silicon-bonded hydrogen, the silicon-bonded aliphatically unsaturated group(s) and the silicon-bonded hydrogen atom(s) may be present in any M, D, and/or T siloxy unit present in the organopolysiloxane, and may be bonded to the same silicon atom (in the case of M and/or D siloxy units). The organopolysiloxane may comprise, for example, as M siloxy units: (R⁶₃SiO_{1/2}), (R⁶₂HSiO_{1/2}), (R⁶H₂SiO_{1/2}), and/or (H₃SiO_{1/2}). The organopolysiloxane may comprise, for example, as D siloxy units: (R⁶₂SiO_{2/2}), (R⁶HSiO_{2/2}), and/or (H₂SiO_{2/2}). The organopolysiloxane may comprise, for example, as T siloxy units: (R⁶SiO_{3/2}) and/or (HSiO_{3/2}). Such siloxy units may be combined in any manner, optionally along with Q siloxy units, to give an organopolysiloxane having at least one silicon-bonded aliphatically unsaturated group designated by R⁶ and at least one silicon-bonded hydrogen atom.

For example, the organopolysiloxane may have any one of the following formulas:

(R⁶₂HSiO_{1/2})_{w′}(R⁶₂SiO_{2/2})_{x′}(R⁶SiO_{3/2})_{y′}(SiO_{4/2})_{z′},

(R⁶H₂SiO_{1/2})_{w′}(R⁶₂SiO_{2/2})_{x′}(R⁶SiO_{3/2})_{y′}(SiO_{4/2})_{z′},

(R⁶₃SiO_{1/2})_{w′}(R⁶HSiO_{2/2})_{x′}(R⁶SiO_{3/2})_{y′}(SiO_{4/2})_{z′},

(R⁶H₂SiO_{1/2})_{w′}(R⁶HSiO_{2/2})_{x′}(R⁶SiO_{3/2})_{y′}(SiO_{4/2})_{z′},

(R⁶₃SiO_{1/2})_{w′}(R⁶²SiO_{2/2})_{x′}(HSiO_{3/2})_{y′}(SiO_{4/2})_{z′},

(R⁶₃SiO_{1/2})_{w′}(R⁶HSiO_{2/2})_{x′}(R⁶SiO_{3/2})_{y′}(SiO_{4/2})_{z′}, and/or

(R⁶H₂SiO_{1/2})_{w′}(R⁶HSiO_{2/2})_{x′}(HSiO_{3/2})_{y′}(SiO_{4/2})_{z′},

etc., where each R⁶ is independently selected and defined above (with at least one R⁶ being an aliphatically unsaturated group), and w′, x′, y′, and z′ are independently from ≥0 to ≤1, with the proviso that w′+x′+y′+z″=1.

In the second embodiment, the proviso (2) is true and the composition further comprises (B) a silicon hydride compound including at least one silicon-bonded hydrogen atom per molecule. In these embodiments, the silicon hydride compound (B) may be any compound including at least one silicon-bonded hydrogen atom. Depending on a structure of the silicon hydride compound (B), the silicon hydride compound (B) may be a silane compound, an organosilicon compound, an organohydrogensilane, an organohydrogensiloxane, etc.

The silicon hydride compound (B) can be linear, branched, cyclic, resinous, or have a combination of such structures. In acyclic polysilanes and polysiloxanes, the silicon-bonded hydrogen atom(s) can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms.

In certain embodiments, the silicon hydride compound (B) is of formula R⁹₄₋ₛSiHₛ, where R⁹ is independently selected and may be any silicon-bonded group, and s is selected such that 1≤s≤4. Typically, s is 1, 2, or 3, alternatively 1 or 2. Each Ro is typically independently a substituted or unsubstituted hydrocarbyl group, suitable examples of which are described above. However, R⁹ can be any silicon-bonded group so long as the silicon hydride (B) is still capable of undergoing hydrosilylation via its silicon-bonded hydrogen atom. For example, R⁹ can be a halogen. When the silicon hydride (B) is a silane compound, the silicon hydride (B) can be a monosilane, disilane, trisilane, or polysilane.

In these or other embodiments, the silicon hydride compound (B) may be an organosilicon compound of formula: H_{g′}R¹⁰_{3-g′}Si—R¹¹—SiR¹⁰₂H, wherein each R¹⁰ is an independently selected substituted or unsubstituted hydrocarbyl group, g′ is 0 or 1, and R¹¹ is a divalent linking group. R¹¹ may be a siloxane chain (including, for example, —R¹⁰₂SiO—, —R¹⁰HSiO—, and/or —H₂SiO— D siloxy units) or may be a divalent hydrocarbon group. Typically, the divalent hydrocarbon group is free of aliphatic unsaturation. The divalent hydrocarbon group may be linear, cyclic, branched, aromatic, etc., or may have combinations of such structures.

When g′ is 1, and when R¹¹ is a divalent hydrocarbon group, specific examples of the silicon hydride compound (B) include:

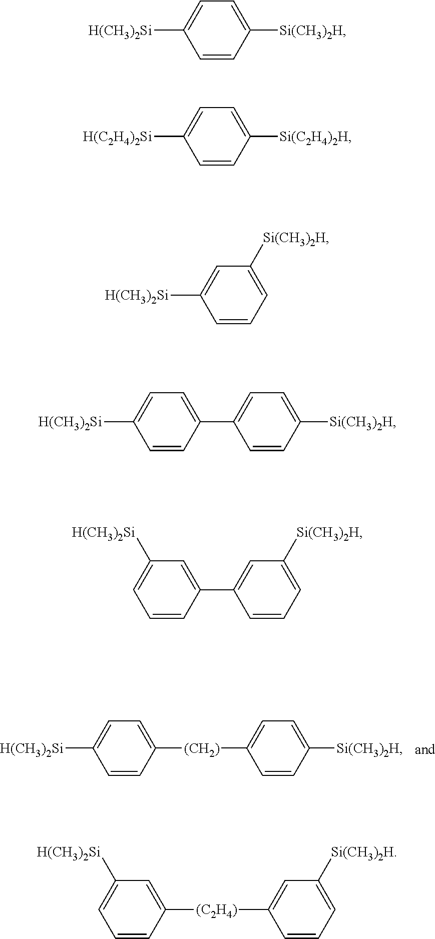

In these or other embodiments, the silicon hydride compound (B) comprises an organohydrogensiloxane, which can be a disiloxane, trisiloxane, or polysiloxane. Examples of organohydrogensiloxanes suitable for use as the silicon hydride compound (B) include, but are not limited to, siloxanes having the following formulae: PhSi(OSiMe₂H)₃, Si(OSiMe₂H)₄, MeSi(OSiMe₂H)₃, and Ph₂Si(OSiMe₂H)₂, wherein Me is methyl, and Ph is phenyl. Additional examples of organohydrogensiloxanes that are suitable for purposes of the silicon hydride compound (B) include 1,1,3,3-tetramethyldisiloxane, 1,1,3,3-tetraphenyldisiloxane, phenyltris(dimethylsiloxy)silane, 1,3,5-trimethylcyclotrisiloxane, a trimethylsiloxy-terminated poly(methylhydrogensiloxane), a trimethylsiloxy-terminated poly(dimethylsiloxane/methylhydrogensiloxane), and a dimethylhydrogensiloxy-terminated poly(methylhydrogensiloxane).

When the silicon hydride compound (B) comprises an organohydrogensiloxane, the silicon hydride compound (B) may comprise any combination of M, D, T and/or Q siloxy units, so long as the silicon hydride compound (B) includes at least one silicon-bonded hydrogen atom. These siloxy units can be combined in various manners to form cyclic, linear, branched and/or resinous (three-dimensional networked) structures. The silicon hydride compound (B) may be monomeric, polymeric, oligomeric, linear, branched, cyclic, and/or resinous depending on the selection of M, D, T, and/or Q units.

Because the silicon hydride compound (B) includes at least one silicon-bonded hydrogen atom, with reference to the siloxy units set forth above, the silicon hydride compound (B) may comprise any of the following siloxy units including silicon-bonded hydrogen atoms, optionally in combination with siloxy units which do not include any silicon-bonded hydrogen atoms:

(R¹⁰₂HSiO_{1/2}), (R¹⁰H₂SiO_{1/2}), (H₃SiO_{1/2}), (R¹⁰HSiO_{2/2}), (H₂SiO_{2/2}), and/or (HSiO_{3/2}),

where R¹⁰ is independently selected and defined above.

In specific embodiments, for example when the silicon hydride compound (B) is linear, the silicon hydride compound (B) may have the average formula:

(R¹⁰₃SiO_{1/2})_{e″}(R¹⁰₂SiO_{2/2})_{f′″}(R¹⁰HSiO_{2/2})_{g″},

wherein each R¹⁰ is independently hydrogen or R⁸, where each R⁸ is independently selected and defined above, and e″≥2, f′″≥0, and g″≥2. In specific embodiments, e″is from 2 to 10, alternatively from 2 to 8, alternatively from 2 to 6. In these or other embodiments, f″is from 0 to 1,000, alternatively from 1 to 500, alternatively from 1 to 200. In these or other embodiments, g″ is from 2 to 500, alternatively from 2 to 200, alternatively from 2 to 100.

In one embodiment, the silicon hydride compound (B) is linear and includes one or more pendent silicon-bonded hydrogen atoms. In these embodiments, the silicon hydride compound (B) may be a dimethyl, methyl-hydrogen polysiloxane having the average formula;

(CH₃)₃SiO[(CH₃)₂SiO]_{f′″}[(CH₃)HSiO]_{g″}Si(CH₃)₃

where f′″ and g″ are defined above.

In these or other embodiments, the silicon hydride compound (B) is linear and includes terminal silicon-bonded hydrogen atoms. In these embodiments, the silicon hydride compound (B) may be an SiH terminal dimethyl polysiloxane having the average formula:

H(CH₃)₂SiO[(CH₃)₂SiO]_{f′″}Si(CH₃)₂H

where f′″ is as defined above. The SiH terminal dimethyl polysiloxane may be utilized alone or in combination with the dimethyl, methyl-hydrogen polysiloxane disclosed immediately above. Further, the SiH terminal dimethyl polysiloxane may have one trimethylsiloxy terminal such that the SiH terminal dimethyl polysiloxane may have only one silicon-bonded hydrogen atom. Alternatively still, the (B) organohydrogensiloxane may include both pendent and terminal silicon-bonded hydrogen atoms.

In certain embodiments, the silicon hydride compound (B) may have one of the following average formulas:

(R¹⁰₃SiO_{1/2})_{e″}(R⁸₂SiO_{2/2})_{f′″}(R⁸HSiO_{2/2})_{g″(R}⁸SiO_{3/2})ₕ,

(R¹⁰₃SiO_{1/2})_{e″}(R⁸₂SiO_{2/2})_{f′″}(R⁸HSiO_{2/2})_{g}(SiO_{4/2})ᵢ,

(R¹⁰₃SiO_{1/2})_{e″}(R⁸₂SiO_{2/2})_{f′41} (R⁸HSiO_{2/2})_{g″}(R⁸SiO_{3/2})ₕ(SiO_{4/2})ᵢ,

wherein each R¹⁰ and R⁸ is independently selected and defined above, e″, f′″, and g″ are defined above, and h≥0, and i is ≥0. In each of the average formulas above, the sum of the subscripts is 1.

Some of the average formulas above for the silicon hydride compound (B) are resinous when the silicon hydride compound (B) includes T siloxy units (indicated by subscript h) and/or Q siloxy units (indicated by subscript i). When the silicon hydride compound (B) is resinous, the silicon hydride compound (B) is typically a copolymer including T siloxy units and/or Q siloxy units, in combination with M siloxy units and/or D siloxy units. For example, the organohydrogenpolysiloxane resin can be a DT resin, an MT resin, an MDT resin, a DTQ resin, an MTQ resin, an MDTQ resin, a DQ resin, an MQ resin, a DTQ resin, an MTQ resin, or an MDQ resin.

In various embodiments in which the silicon hydride compound (B) is resinous, or comprises an organopolysiloxane resin, the silicon hydride compound (B) typically has the formula:

(R¹²₃SiO_{1/2})_{j′}(R¹²₂SiO_{2/2})_{k′}(R¹²SiO_{3/2})_{l′}(SiO_{4/2})_{m″} (IV)

wherein each R¹² independently is H or a substituted or unsubstituted hydrocarbyl group, with the proviso that in one molecule, at least one R¹² is H; and wherein 0≤j′≤1; 0≤k′≤1; 0≤l′≤1; and 0≤m″≤1; with the proviso that j′+k′+l′+m″=1.

In certain embodiments, the silicon hydride compound (B) may comprise an alkylhydrogen cyclosiloxane or an alkylhydrogen dialkyl cyclosiloxane copolymer, represented in general by the formula (R¹²₂SiO)_{r′}(R¹²HSiO)_{s′}, where R¹² is independently selected and defined above, and where r′ is an integer from 0-7 and s′ is an integer from 3-10. Specific examples of suitable organohydrogensiloxanes of this type include (OSiMeH)₄, (OSiMeH)₃(OSiMeC₆H₁₃), (OSiMeH)₂(OSiMeC₆H₁₃)₂, and (OSiMeH)(OSiMeC₆H₁₃)₃, where Me represents methyl (—CH₃).

The silicon hydride compound (B) can be a single silicon hydride compound or a combination comprising two or more different silicon hydride compounds.

Finally, in a third embodiment, both proviso (1) and proviso (2) are true such that the unsaturated compound (A) also includes at least one silicon-bonded hydrogen atom per molecule, and the composition further comprises (B) a silicon hydride compound including at least one silicon-bonded hydrogen atom per molecule. Examples of suitable unsaturated compounds and silicon hydride compounds for this third embodiment are set forth above.

The unsaturated compound (A), as well as the silicon hydride compound (B), if present in the composition, may be disposed in a carrier vehicle. Examples of carrier vehicles are described.

The composition may comprise the unsaturated compound (A) and the silicon hydride compound (B), when present, in varying amounts or ratios contingent on desired properties or end use application of the composition. In various embodiments when the composition comprises components (A) and (B), the composition comprises components (A) and (B) in an amount to provide a mole ratio of silicon-bonded hydrogen atoms to aliphatically unsaturated groups of from 0.3 to 5, alternatively from 0.6 to 3.

The composition further comprises (C) the catalyst as described above.

The catalyst (C) is present in the composition in a catalytic amount, i.e., an amount or quantity sufficient to promote a reaction or curing thereof at desired conditions. The catalytic amount of the catalyst (C) may be greater than 0.01 ppm, and may be greater than 1,000 ppm (e.g., up to 10,000 ppm or more). In certain embodiments, the typical catalytic amount of catalyst (C) is less than 5,000 ppm, alternatively less than 2,000 ppm, alternatively less than 1,000 ppm (but in any case greater than 0 ppm). In specific embodiments, the catalytic amount of the catalyst (C) may range from 0.01 to 1,000 ppm, alternatively from 0.01 to 100, alternatively from 0.01 to 50, alternatively from 5 to 50, alternatively from 10 to 40, alternatively from 15 to 35, ppm of metal based on the weight of components (A)-(C). The ranges may relate solely to the metal content within the catalyst (C). As understood in the art, the catalytic amount of the catalyst may be a function of the selection of components (A) and (B).

The composition may further comprise one or more optional components, including adhesion promoters, carrier vehicles, dyes, pigments, anti-oxidants, heat stabilizers, flame retardants, flow control additives, biocides, fillers (including extending and reinforcing fillers), surfactants, thixotroping agents, organopolysiloxanes, water, carrier vehicles or solvents, pH buffers, etc. In certain embodiments, the composition is free from any hydrosilylation inhibitors.

The composition may be in any form and may be incorporated into further compositions, e.g. as a component of a composition. For example, the composition may be in the form of, or incorporated into, an emulsion. The emulsion may be an oil-in-water emulsion, water-in-oil emulsion, silicone-in-oil emulsion, etc. The composition itself may be a continuous or discontinuous phase of such an emulsion.

The composition may be prepared by combining components (A), (B), and (C), along with any optional components, in any order of addition, optionally with a master batch, and optionally under shear.

A method of preparing a hydrosilylation reaction product is also provided. The hydrosilylation reaction product is formed from the composition and may take a variety of forms depending on a section of the components in the composition.

The method comprises reacting an aliphatically unsaturated group and a silicon-bonded hydrogen atom in the presence of the catalyst (C). The catalyst (C) can be utilized in any hydrosilylation reaction, e.g. in lieu of or in addition to conventional hydrosilylation catalysts.

The aliphatically unsaturated group is present in the unsaturated compound (A). At least one of the following two provisos applies: (1) the unsaturated compound (A) also includes at least one silicon-bonded hydrogen atom per molecule; and/or (2) the silicon-bonded hydrogen atom is present in the silicon hydride (B) compound separate from the unsaturated compound (A). In a first embodiment, the proviso (1) is true such that the unsaturated compound (A) also includes at least one silicon-bonded hydrogen atom per molecule. In a second embodiment, the proviso (2) is true such that the composition further comprises (B) a silicon hydride compound including at least one silicon-bonded hydrogen atom per molecule. Finally, in a third embodiment, both proviso (1) and proviso (2) are true such that the unsaturated compound (A) also includes at least one silicon-bonded hydrogen atom per molecule, and that the composition further comprises the silicon hydride compound (B) including at least one silicon-bonded hydrogen atom per molecule. These embodiments are described in detail above with respect to the composition itself.

The hydrosilylation-reaction product prepared via the method is not limited and is generally a function of the unsaturated compound (A) and, if utilized, the silicon hydride compound (B). For example, the hydrosilylation-reaction product may be monomeric, oligomeric, polymeric, resinous, etc. The hydrosilylation-reaction product may comprise a fluid, an oil, a gel, an elastomer, a rubber, a resin, etc. The hydrosilylation-reaction product may take any form, as understood in the art, based on the selection of the unsaturated compound (A) and, if utilized, the silicon hydride compound (B).

In specific embodiments, the composition is utilized to prepare an elastomer, such as a gel and/or a paste. In these embodiments, the hydrosilylation reaction product formed with the composition is the elastomer. In these or other embodiments, the hydrosilylation reaction product has a viscosity that can be measured at 25° C., in the absence of any solvent. Typically, the viscosity of the hydrosilylation reaction product is measurable at 25° C. via a Brookfield LV DV-E viscometer with a spindle selected as appropriate to the viscosity of the silicate resin. One of skill in the art understands how to select components (A) and (B) to give an elastomer as the hydrosilylation reaction product. In certain embodiments, the hydrosilylation reaction product has a viscosity that does not increase by more than 800,000, alternatively not more than 700,000, alternatively not more than 600,000, alternatively not more than 500,000, alternatively not more than 450,000, cP after 5, alternatively after 6, alternatively after 7, alternatively after 8, alternatively after 9, alternatively fatter 10, days of storage at room temperature.

The hydrosilylation-reaction product may also include various byproducts formed via the hydrosilylation reaction. For example, the hydrosilylation-reaction product typically includes a target species and various byproducts. The hydrosilylation-reaction product may also include other components, e.g. a carrier or solvent, if the method and reaction is carried out therein and/or if the composition includes such components. The method may further comprise isolating the target species, e.g. via any suitable purification method.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

The following examples are intended to illustrate the invention and are not to be viewed in any way as limiting to the scope of the invention.

The various components utilized in the Examples are set forth in Table 1 below.

TABLE 1
Components/Compounds Utilized

| Component | Description |
|---|---|
| Imidazole Compound 1 | 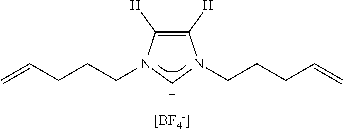 |
| Imidazole Compound 2 | 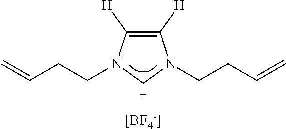 |
| Imidazole Compound 3 | 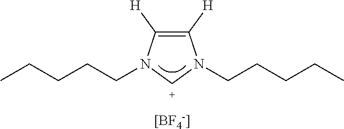 |
| Imidazole Compound 4 | 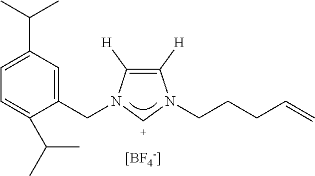 |
| | 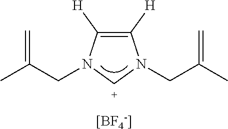 |
| Platinum Complex | Karstedt's catalyst in xylene (~2.1-2.4 wt. % Pt) |
| Base Reagent | Potassium tert-butoxide |
| Catalyst 1 | 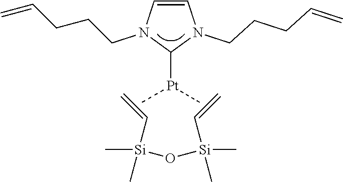 |
| Catalyst 2 | 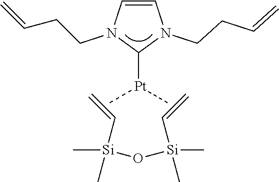 |
| Catalyst 3 | 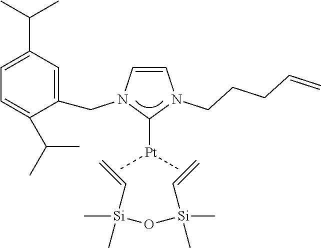 |
| Comparative Catalyst 1 | 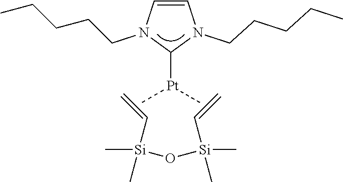 |
| Comparative Catalyst 2 | 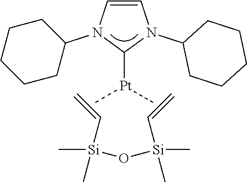 |
| Comparative Catalyst 3 | 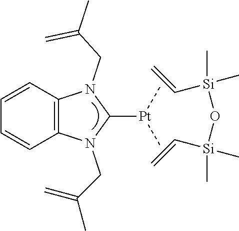 |
| Unsaturated | 1,5-hexadiene |
| Compound (A) | |
| Silicon Hydride (B) | A bis-trimethyl-siloxy-terminated |
| | poly(dimethyl/methylhydrogen)siloxane copolymer with average unit |
| | formula: M₂D_{92.3}D^{H}_{6.2}, where M is [(CH₃)₃SiO_{1/2}]; D is |
| | [(CH₃)₂SiO_{2/2}], and D^{H} is [(CH₃)(H)SiO_{2/2}]. |
| Organopolysiloxane | Trimethylsiloxy-endblocked polydimethylsiloxane having a capillary |
| | viscosity at 25° C. of 5 cSt. Capillary viscosity (kinematic viscosity via |
| | glass capillary) was measured via Dow Corning Corporate Test |
| | Method CTM0004 method of 20 Jul. 1970. CTM0004 is known in the |
| | art and based on ASTM D445, IP 71. |

### EXAMPLE 1

### Synthesis of Catalyst 1

In a nitrogen glove box, a 20 mL scintillation vial was charged with Imidazole Compound 1 (0.0151 g, 0.0517 mmol, 1.1 eq.), Base Reagent (0.00790 g, 0.0704 mmol, 1.5 eq.), and Platinum Complex (0.5 mL, 1 eq.). Solvent (3 mL) and a stir bar were added before taping up the vile to prevent light exposure during the 24-hour reaction period. The contents of the vial were stirred at 780 rpm for 24 hours at room temperature to give a reaction mixture. The reaction mixture was dried in vacuo, redissolved in pentane, and filtered to give a filtrate. The filtrate was then dried in vacuo to yield Catalyst 1 as a yellow oil in an 86% yield. ¹H NMR (500 MHz, C₆D₆): δ: 6.25 (d, J=6.6 Hz, 2H), 5.56 (d, J=41.6 Hz, 2H), 5.03-4.80 (m, 4H), 3.59 (dt, J=62.8, 7.1 Hz, 4H), 2.60 (d, J=11.4 Hz, 2H), 2.32 (d, J=51.1 Hz, 4H), 1.75 (dd, J=97.5, 8.7 Hz, 4H), 1.50 (dd, J=61.4, 7.5 Hz, 4H), 0.65 (s, 6H), 0.03 (s, 6H).

### EXAMPLE 2

### Synthesis of Catalyst 2

In a nitrogen glove box, a 20 mL scintillation vial was charged with Imidazole Compound 2 (0.0135 g, 0.0517 mmol, 1.1 eq.), Base Reagent (0.00790 g, 0.0704 mmol, 1.5 eq.), and Platinum Complex (0.5 mL, 1 eq.). Solvent (3 mL) and a stir bar were added before taping up the vile to prevent light exposure during the 24-hour reaction period. The contents of the vial are stirred at 780 rpm for 24 hours at room temperature to give a reaction mixture. The reaction mixture was dried in vacuo, redissolved in pentane, and filtered to give a filtrate. The filtrate was then dried in vacuo to yield Catalyst 2 as a yellow oil in an 85% yield. ¹H NMR (500 MHz, C₆D₆): δ: 6.21 (t, J=6.0 Hz, 2H), 5.57-5.32 (ddt, J=90.8, 17.1, 7.1 Hz, 2H), 4.95-4.79 (m, 4H), 3.73-3.55 (dt, J=69.6, 6.8 Hz, 4H), 2.67-2.54 (m, 2H), 2.42-2.23 (m, 4H), 2.11 (dq, J=63.4, 6.3 Hz, 4H), 0.70 (s, 6H), 0.07 (s, 6H).

### EXAMPLE 3

### Synthesis of Catalyst 3

In a nitrogen glove box, a 20 mL scintillation vial was charged with Imidazole Compound 4 (0.0197 g, 0.0517 mmol, 1.1 eq.), Base Reagent (0.00790 g, 0.0704 mmol, 1.5 eq.), and Platinum Complex (0.5 mL, 1 eq.). Solvent (3 mL) and a stir bar were added before taping up the vile to prevent light exposure during the 24-hour reaction period. The contents of the vial are stirred at 780 rpm for 24 hours at room temperature to give a reaction mixture. The reaction mixture was dried in vacuo, redissolved in pentane, and filtered to give a filtrate. The filtrate was then dried in vacuo to yield Catalyst 3 as a yellow oil in a 79% yield. ¹H NMR (500 MHz, C₆D₆): δ: 7.10 (t, J=7.7 Hz, 1H), 6.97 (d, J=7.8 Hz, 2H), 6.57 (d, J=2.4 Hz, 1H), 6.41 (d, J=2.4 Hz, 1H), 5.60 (ddt, J=16.9, 10.2, 6.7 Hz, 1H), 4.97-4.89 (m, 2H), 3.80 (t, J=7.2 Hz, 2H), 2.85 (p, J=6.8 Hz, 2H), 2.41-2.34 (m, 2H), 2.24-2.07 (m, 4H), 1.83 (p, J=7.2 Hz, 2H), 1.58 (p, J=7.6 Hz, 2H), 1.21 (d, J=6.8 Hz, 6H), 0.97 (d, J=6.9 Hz, 6H), 0.59 (s, 6H).

### COMPARATIVE EXAMPLE 1

### Synthesis of Comparative Catalyst 1

In a nitrogen glove box, a 20 mL scintillation vial was charged with Imidazole Compound 3 (0.0152 g, 0.0517 mmol, 1.1 eq.), Base Reagent (0.00790 g, 0.0704 mmol, 1.5 eq.), and Platinum Complex (0.5 mL, 1 eq.). Solvent (3 mL) and a stir bar were added before taping up the vile to prevent light exposure during the 24-hour reaction period. The contents of the vial were stirred at 780 rpm for 24 hours at room temperature to give a reaction mixture. The reaction mixture was dried in vacuo, redissolved in pentane, and filtered to give a filtrate. The filtrate was then dried in vacuo to yield Comparative Catalyst 1 as a yellow oil in an 87% yield. ¹H NMR (500 MHz, C₆D₆): δ: 6.28 (d, J=5.5 Hz, 2H), 3.66 (t, J=7.6 Hz, 2H), 3.54 (t, J=7.6 Hz, 2H), 2.69-2.56 (m, 2H), 2.42-2.19 (m, 4H), 1.45 (p, J=7.9 Hz, 2H), 1.34 (p, J=7.7 Hz, 2H), 1.16-1.12 (m, 2H), 1.10-1.06 (m, 2H), 1.04-1.0 (m, 2H), 0.89 (q, J=7.5 Hz, 2H), 0.78 (t, J=7.2 Hz, 3H), 0.73 (t, J=7.5 Hz, 3H), 0.69 (s, 6H), 0.07 (s, 6H).

### COMPARATIVE EXAMPLE 2

### Synthesis of Comparative Catalyst 3

In a nitrogen glove box, a 20 mL scintillation vial was charged with Imidazole Compound 5 (0.0159 g, 0.0517 mmol, 1.1 eq), Base Reagent (0.00790 g, 0.0704 mmol, 1.5 eq), and Platinum Complex (0.5 mL, 1 eq). Solvent (3 mL) and a stir bar were added before taping up the vile to prevent light exposure during the 24-hour period. The contents of the vial were stirred at 780 rpm for 24 hours at room temperature to give a reaction mixture. The reaction mixture was dried in vacuo, redissolved in pentane, and filtered to give a filtrate. The filtrate was then dried in vacuo to yield Comparative Catalyst 3 as a brown waxy solid in a 79% yield. ¹H NMR (500 MHz, C₆D₆) δ: 7.01-6.93 (m, 4H), 4.69 (dt, J=10.4, 1.6 Hz, 2H), 4.64 (s, 2H), 4.55 (s, 2H), 4.52 (s, 1H), 4.43 (s, 1H), 2.80-2.66 (m, 2H), 2.55-2.34 (m, 4H), 1.51 (s, 3H), 1.34 (s, 3H), 0.71 (s, 6H), 0.08 (s, 6H).

### GENERAL PROCEDURE FOR EXAMPLES 4-6 AND COMPARATIVE EXAMPLES 3-12

The same general procedure is utilized to prepare silicone elastomer blends in Examples 4-6 and Comparative Examples 3-12. In particular, 9.16 g of Silicon Hydride (B) and 50.53 g of Organopolysiloxane were disposed in a 4 oz. squat jar with a cross stir bar at 200 revolutions per minute (rpm). The contents of the jar were heated to 70° C. and then 0.36 g of Unsaturated Compound (A) and a particular catalyst in a certain amount (as identified below) were disposed in the jar to give a mixture. After gelling of the mixture results in a gel (as indicated by the cross stir bar no longer stirring the gel), the gel was placed into an oven at 70° C. for 3 h and then sheered down with a blender to form a paste. The gel was sheared with a blender for 30 seconds at setting 1, 30 seconds at setting 2, and then 30 seconds at setting 3. Viscosity was measured using a Brookfield programmable DV-II viscometer (spinning at 2.5 rpm) initially and incrementally over a 10-day period or until failure occurred (defined below). It is generally considered as failure when the delta between the initial viscosity and the viscosity after 10 days exceeds 500 k Cp. In Table 2 below, C.E. indicates Comparative Example, CC indicates Comparative Catalyst, and X indicates no measurement was taken. Color was determined visually. Viscosity values in Table 2 are rounded to the nearest 10,000.

TABLE 2
Viscosity Drift of Examples 4-6 and Comparative Examples 3-12

| | | Catalyst | | | | | | | |
|---|---|---|---|---|---|---|---|---|---|
| | | Amount | Viscosity Drift at 25° C. (Cp) | | | | | | |
| Example: | Catalyst: | (ppm) | 0 day | 1 day | 2 day | 3 day | 10 day | Delta | Color |
| 4 | 1 | 9.7 | X | X | X | X | X | X | X |
| 5 | 1 | 20 | 450k | 450k | 550k | 700k | 800k | 350k | None |
| 6 | 1 | 43 | 480k | 900k | 1600k | 2000k | X | 1520k | None |
| C.E. 3 | Platinum | 9.7 | 850k | 1600k | 1800k | 1800k | 1800k | 950k | Yellow |
| | Complex | | | | | | | | |
| C.E. 4 | Platinum | 9.7 | 680k | 1300k | 1800k | 1800k | 1600k | 1120k | X |
| | Complex | | | | | | | | |
| C.E. 5 | CC1 | 9.7 | 680k | 1350k | 1600k | 1700k | X | 1020k | None |
| C.E. 6 | CC1 | 20 | 920k | 1650k | 1800k | 2200k | X | 1280k | None |
| C.E. 7 | CC1 | 43 | 680k | 1220k | 1750k | 2050k | X | 1370k | None |
| C.E. 8 | CC2 | 9.7 | 760k | 1280k | 1800k | 1800k | X | 1040k | None |
| C.E. 9 | CC2 | 20 | 1000k | 1700k | 1800k | 2150k | X | 1150k | None |
| C.E. 10 | CC2 | 43 | 1200k | 2000k | 2150k | 2300k | X | 1100k | None |
| C.E. 11 | CC3 | 20 | 1200k | 1850k | 2150k | 2200k | X | 1000k | None |
| C.E. 12 | CC3 | 43 | 1400k | 2300k | 2500k | 2500k | X | 1100k | None |

1. A catalyst for hydrosilylation, said catalyst comprising a complex having the following structure: 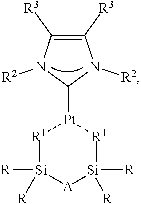
wherein A is O or N; each R is an independently selected hydrocarbyl group; each R¹ is an independently selected ethylenically unsaturated group; each R² is an independently selected hydrocarbyl group, with the proviso that at least one of R² includes terminal ethylenic unsaturation, with at least one of R² having the formula —(CH₂)ₙCH═CH₂, where n is independently from 2 to 8; and each R³ is independently selected from H and R, with the proviso that when each R³ is R, two of R³ may be bonded together as a ring structure.

2. The catalyst of claim 1, wherein n is independently from 2 to 7.

3. The catalyst of claim 1, wherein: (i) each R is methyl; (ii) each R¹ is vinyl; (iii) each R² includes terminal ethylenic unsaturation; (iv) each R³ is H; (v) A is O;
or (vi) any combination of (i) to (v).

4. The catalyst of claim 1, having the following structure: 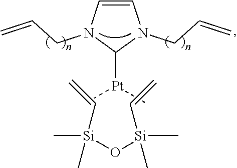
where each subscript n is independently from 2 to 8.

5. A method of preparing a catalyst for hydrosilylation, said method comprising:
reacting a platinum complex and an imidazole compound in the presence of a base reagent to give the catalyst for hydrosilylation,
wherein the platinum complex is of the formula: 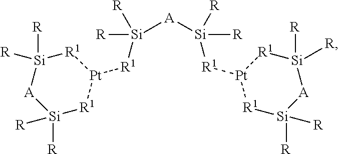
and
wherein the imidazole compound is of the formula: 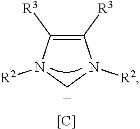
wherein A is O or N; C⁻ is a counterion; each R is an independently selected hydrocarbyl group; each R¹ is an independently selected ethylenically unsaturated group; each R² is an independently selected hydrocarbyl group, with the proviso that at least one of R² includes terminal ethylenic unsaturation; and each R³ is independently selected from H and a hydrocarbyl group, with the proviso that when each R³ is a hydrocarbyl group, two of R³ may be bonded together as a ring structure.

6. The method of claim 5, wherein at least one of R² has the formula—(CH₂)ₙCH═CH₂, where n is independently from 2 to 8.

7. The method of claim 5, wherein: (i) each R is methyl; (ii) each R¹ is vinyl; (iii) each R² includes terminal ethylenic unsaturation; (iv) each R³ is H; (v) A is O;
or (vi) any combination of (i) to (v).

8. The method of claim 5, wherein the base reagent comprises an alkali metal alkoxide.

9. A composition, comprising:
(A) an unsaturated compound including at least one aliphatically unsaturated group per molecule, subject to at least one of the following two provisos:
(1) the unsaturated compound (A) also includes at least one silicon-bonded hydrogen atom per molecule; and/or
(2) the composition further comprises (B) a silicon hydride compound including at least one silicon-bonded hydrogen atom per molecule; and
(C) the catalyst of claim 1.

10. The composition of claim 9, wherein proviso (2) is true such that composition further comprises (B) the silicon hydride compound including at least one silicon-bonded hydrogen atom per molecule.

11. The composition of claim 10, wherein: (i) the unsaturated compound (A) includes at least two unsaturated groups per molecule; (ii) the silicon hydride compound (B) includes at least two silicon-bonded hydrogen atoms per molecule; (iii) the catalyst is present in an amount of from 10 to 40 ppm based on the total weight of components (A)-(C); or (iv) any combination of (i) to (iii).

12. A method of preparing a hydrosilylation reaction product, said method comprising:
reacting an aliphatically unsaturated group and a silicon-bonded hydrogen atom in the presence of (C) a hydrosilylation catalyst to give the hydrosilylation reaction product;
wherein the aliphatically unsaturated group is present in (A) an unsaturated compound; wherein at least one of the following two provisos applies:
(1) the unsaturated compound (A) also includes at least one silicon-bonded hydrogen atom per molecule; and/or
(2) the silicon-bonded hydrogen atom is present in (B) a silicon hydride compound separate from the unsaturated compound (A); and
wherein the (C) hydrosilylation catalyst comprises the catalyst of claim 1.

13. A hydrosilylation reaction product formed in accordance with the method of claim 12.

14. A hydrosilylation-curable silicone composition comprising the catalyst of claim 1.

15. A method of extending stability of a silicone elastomer blend, said method comprising combining a hydrosilylation-curable silicone composition and the catalyst of claim 1 to give a silicone elastomer blend having extended stability.
